(19) United States
(12) Patent Application Publication
(10) Pub. No.: US 2006/0040550 A1
(43) Pub. Date: Feb. 23, 2006

(54) Cord locking display collar and system and method for presenting connector for point of sale access prior to purchase

(76) Inventor: Gregory Robert Slauson, Gladstone, OR (US)

Correspondence Address: DELLETT & WALTERS, P. O. BOX 82788, PORTLAND, OR, 97282-0788, US

(21) Appl. No.: 11/206,677

(22) Filed: Aug. 17, 2005

Related U.S. Application Data
(60) Provisional application No. 60/603,704, filed on Aug. 23, 2004.

(51) Int. Cl. H01R 31/08

(52) U.S. Cl. 439/507

(57) ABSTRACT

A packaging configuration of a device inside a package maintains a plug or connector of the device accessible externally of the package, without having to open the package. The plug or connector is accessible to test the connectivity or to power or communicate with the device.

### BACKGROUND OF THE INVENTION

This invention relates to packaging of cables, electronic device chargers and other items employing connectors.

Often, in the case of purchasing accessories (e.g., chargers, connection cables, headphones, headsets, hands free devices) for electronic devices, such as cellular phones, for example, consumers are overwhelmed by the large selection of different connection plugs available. Determining which plug type and size will fit the particular phone or device can be difficult. Further, once they have what they believe to be the correct plug the consumers can be frustrated when trying to open the clamshell package in which such items are typically sold. After opening the package, the consumer may determine that in fact the connector does not fit the device, and is the incorrect connector type. This leads to frustration for the consumer, and is likely to result in the accessory item being returned to the point of purchase. Since the packaging has been opened already, the vendor will now have to repackage the item for later resale, or will have to sell the product at a discount as a returned item.

### SUMMARY OF THE INVENTION

In accordance with the invention, a system and method are provided to enable access to a connector plug of an accessory or cable without having to open the packaging in which the accessory or cable are packaged for sale. A collar member and corresponding locking member interact with the package, to hold the connector plug outside of the package for access for testing the fit of the plug prior to purchase.

Accordingly, it is an object of the present invention to provide an improved point of sales packaging for enabling testing of connections with devices prior without having to open the packaging.

It is a further object of the present invention to provide an improved method of presenting electronic device accessories for sale while allowing access to connector plugs for testing the fit thereof prior to purchase.

It is yet another object of the present invention to provide an improved manner to access a connector cable of a device in a package without having to open the package.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a top view of a clamshell package employing the invention;

FIG. 2 is a sectional view taken along line 2-2 of FIG. 1;

FIG. 3 is a perspective view of a lock collar portion of the device according to the invention;

FIG. 4 is a perspective view of an end cover portion of the device;

FIG. 5 is a perspective view of a cotter pin portion of the device;

FIG. 6 is a perspective view of the lock collar, end cover portion of FIG. 4 and cotter pin of FIG. 5 when assembled; and

FIG. 7 is a perspective view of an alternative end cover portion.

### DETAILED DESCRIPTION

The system according to a preferred embodiment of the present invention comprises a base member and locking portion that interact with the wall of a point of sale clamshell package to securely hold a connector plug externally of the clamshell package, to enable access to the plug for testing of fit before purchase of the package.

A clamshell package is typically two parts, usually a front and a back molded alongside each other connected (all as one piece) that can be closed together in the manner of an actual clam shell.

A blister package is a molded plastic container that can be affixed to a cardboard backing, the blister package can also be made to fit around the cardboard backing, so you can simply slip the cardboard into the plastic package.

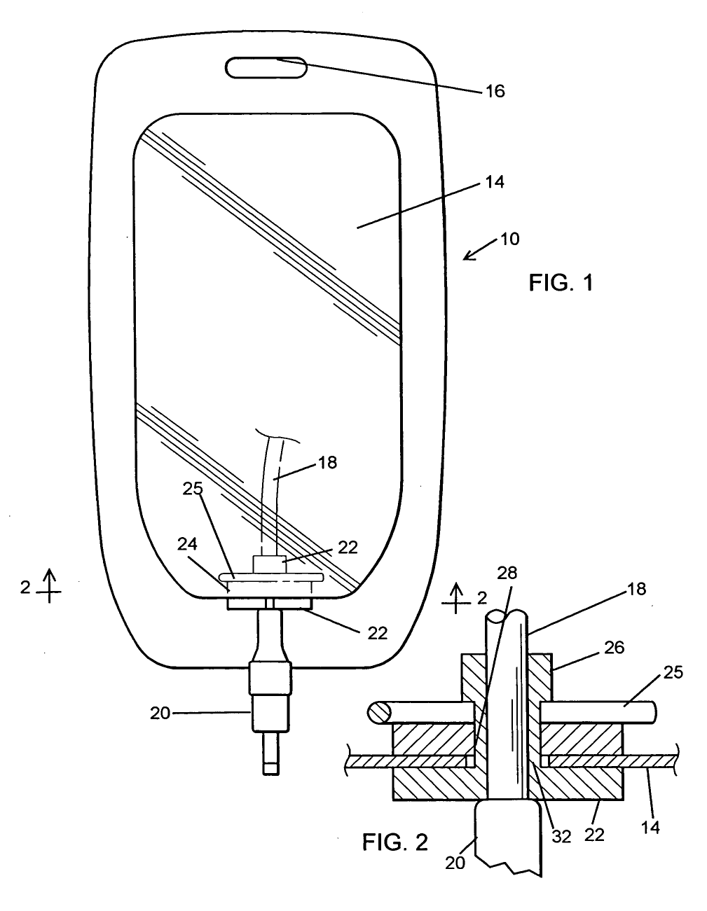

Referring to FIG. 1, a top view of a clamshell package employing the invention therewith, the package 10 typically includes a base flange or backing card 12, which may comprise cardboard or the like, and a top member 14, typically made of some type of plastic, and together, items 12 and 14 define a package with an interior space to receive an item for point of sale presentation. Top member 14 will typically be transparent (at least partially) to enable consumers to view the item held therein. An opening 16 is defined at a top of the package to enable the package to hang at a point of sale location.

Inside the package, an accessory (not visible in FIG. 1) is placed, and may comprise, for example, a cellular telephone charging cord, which may carry a cigarette lighter plug for insertion to a cigarette lighter socket in an automobile. Also, the accessory might be a charger or other item adapted to connect to an electronic device (such as a computer, PDA, phone, game, etc.). In the illustrated example, the accessory has a cable 18 which carries an interface plug 20 at the end of the cable distal from the accessory, to enable the accessory and electronic device (e.g., cellular phone) to be interconnected.

Referring to FIGS. 1, 2, 3, 4 and 5, in accordance with the invention, a base lock collar 22 and an end cover 24 are provided, wherein the base collar 22 is positioned outside the clamshell package, and includes an extending neck portion extending into the package, the neck portion has a wider distal end 26, and a narrower central portion 28. The base collar is suitably provided with a disk-like flange portion 30. The portions 26, 28 and 30 are substantially cylindrical in configuration, with a central through bore 32 that defines a substantially cylindrical opening. The lock collar 22 has a cut-out portion 34 extending radially from the center to the distal edge of the portion 30.

FIG. 4 illustrates the details of the cover portion 24, which is disk-like in appearance, having a central opening 36 sized to have the opening diameter correspond to the outer diameter of portion 28 of the lock collar 22. Cover portion 24 has a cut out portion 38 extending radially from the center to the distal edge of the portion 24.

FIG. 5 illustrates a cotter pin 25, which suitably has a bias to return to a set configuration when bent, so as to allow expanding to fit over the lock collar, but returning to its original shape to assist in keeping the lock collar, cover and package/cable in engagement with one another.

In operation, the clam shell package has an opening therein adapted to receive portions 26 and 28 of lock collar 22 therethrough and also cable 18 and plug 20 therethrough. The cable 18 is passed through the opening 34 in lock collar 22 so that the cable 18 is now positioned in opening 32, the plug portion of cable 18 is passed through the opening of the clamshell so that the plug 20 is now outside of the clamshell package. Portions 26 and 28 are passed through the opening of the clamshell so as to extend to the inside thereof. Flange portion 30 interacts with the outside face of the clamshell package top member 14 to prevent movement of the lock collar beyond the inside face of the clamshell. Lock end cover 24 is then fit over the extended portion of lock collar 22, to fit around the portion 28 thereof. Cotter pin 25 then fits around the portion 28, to further secure the cover portion 24 relative to the lock portion 22. The interaction of the various noted components thus enable the plug 20 to be displayed externally of the clamshell, allowing access to the plug for testing the fit thereof prior to purchase, while keeping the cable substantially secured inside the package. The cable may suitably be looped or knotted inside the package to further prevent it from being pulled beyond the lock collar portion 26. FIG. 6 illustrates the interaction of lock collar 22, lock end cover 24 and cotter pin 25 when joined together (with the cord 18 and clamshell 14 removed, to show the interaction of these components). It will be noted that the space 40 between the flange 30 and cover 24 is the region where the clamshell 14 wall is received.

It will be understood that the configurations shown thereby enable access to the plug portion 20, for testing the fit thereof. Also, the diameter of the openings 32 and 36 may be made such that the cable can be pulled out of or pushed back into the clamshell interior, to allow reaching further from the package with the plug, if desired. In such a case, if the cable is knotted to prevent removal from the package, a sufficient distance from the plug to the knotted portion is provided to allow some movement of the cable out of the package. Alternatively, the diameters can be such that the cable does not readily move, in the case where it is not desired that the cable be so extended or retracted.

While the noted examples of use are for testing fit of a plug, alternatively the plug (or, alternatively, a socket) could also be used to provide power or communications to/from a device inside the packaging, for programming of the device in the package (or an external device), for providing power to a device to test/demonstrate the functions thereof, to recharge a device, or the like.

A further alternative embodiment, rather than have the lock collar be formed as a separate member as in the preferred embodiment, is to have the clamshell package be pre-formed in the configuration of a lock collar. Then, the lock end cover operates to with the pre-formed section of the clamshell to hold the plug and cable in place. A post is molded into the inside of the cavity in the clamshell/blister package, with an open end in the clamshell, to display the plug/connector and fit a number of plugs. The plugs can be secured (e.g. by tying) around the post inside of the cavity to secure the cord inside of the package.

Still further, the clamshell portion can be formed to sufficiently engage the cable and plug so as to hold the plug outside of the clamshell, without needing the lock end cover. This may be accomplished, for example, by the clamshell cover portion around the cable/plug shrinking (such as by application of heat) to fit tightly with the cable/plug.

The clamshell/blister package can be molded around a plug/connector/cord, secured inside of the package by a wire or string, or nylon fastener, or flexible securement device. The securing material can be positioned through holes trough the back of the package and around the plug/connector/cord, or the plug/connector/cord can be attached by two posts molded inside of the clamshell/blister package.

The plug/connector could be displayed outside the molded clamshell/blister package trough the front or back of the package as well as trough the walls of the cavity. The plug/connector/adapter can also be connected to an open front package of varied materials by securing the device to the package trough various means with various materials.

A still further embodiment of the lock collar and lock end covers do not employ the openings 34 or 38, and instead, member 22 and 24 are formed of material with sufficient stretching properties to allow them to stretch to fit over the plug and cable portions for installation, but having sufficient rebound properties to return to original shape and size, so as to maintain the plug in engagement.

Another embodiment involves forming the lock collar on the cable at manufacture time of the cable (or after manufacture). Then after purchase, the consumer can break or tear or cut off the lock collar.

While the embodiments illustrated show electrical connectors and cables, the packaging concept is also applicable to optical cables, tubing connectors and the like.

In accordance with the invention, therefore, a package with a plug or connector extending therefrom is provided to allow access to the plug/connector for testing fit, testing operation of a device, powering, programming or otherwise accessing a device or accessory without having to open the package. This enables a consumer to ensure that the connector plug fits the consumer's device, which may be cellular phone, a PDA, a game console or the like.

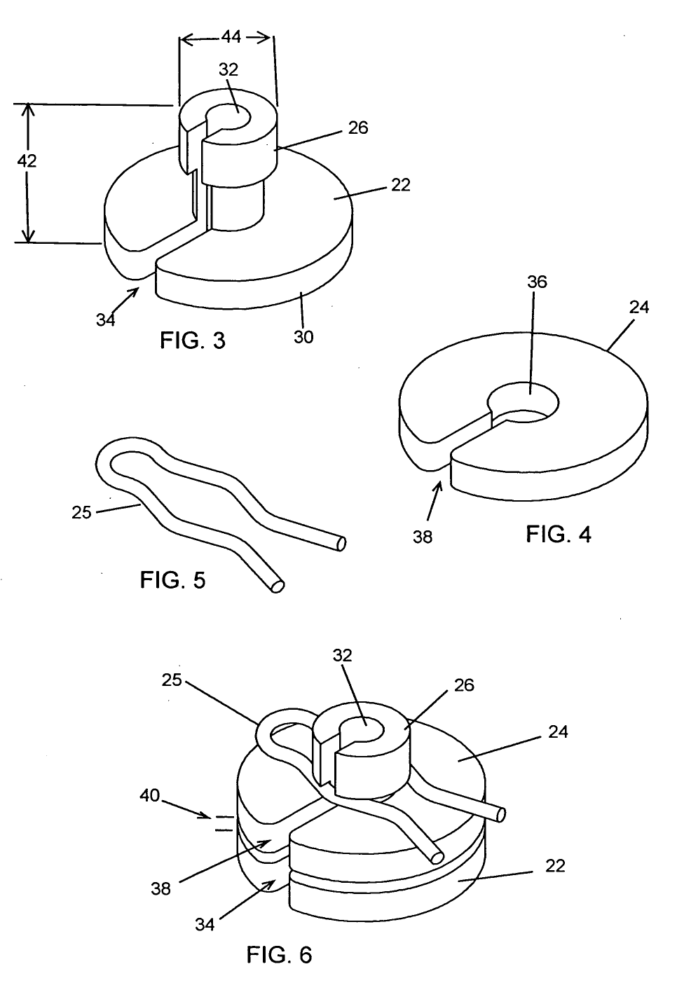

In the preferred embodiment, the lock collar 22 and lock cover member are suitable formed by molding a pliable yet firm rubber or plastic material. Also, injection molding may be employed. In a particular embodiment, the diameter of the flange portion 30 is 2.25 cm. Cover 24 is suitably of similar diameter. The overall height 42 (FIG. 3) is 1.25 cm. The outer diameter 44 of portion 26 is approximately 2.5 mm, while the outer diameter of portion 28 is approximately 1.5 mm. The inner diameter of portion 32 is suitably 0.75 mm. These dimensions will vary, of course, depending on the particular size and configuration of the plug/connector 20 and cable 18 with which the device is used. Also, these diameters are employed with a stiff plastic clamshell package. Other package materials may warrant changes in the diameters to accomplish the desired engagement between the package, lock member and plug.

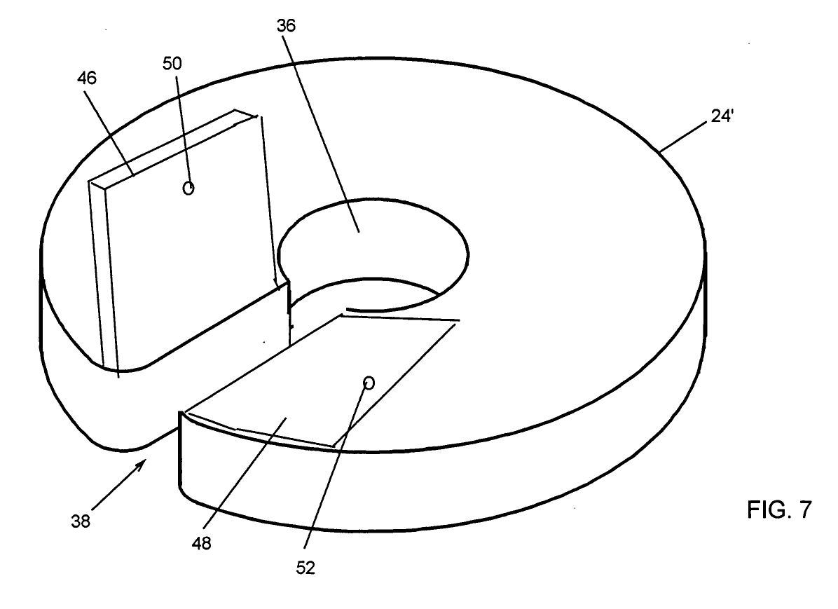

An alternative embodiment of the end cover is shown in FIG. 7. This end cover 24′, includes a flap portion 46 and corresponding depression 48, whereby the flap portion folds down to cover the opening 38, to provide a cover for the opening 38. A protrusion 50 and corresponding depression 52 may be provided to engage or align the flap and depression.

Advantages thereby provided include enabling a consumer with little or no knowledge of the variety of plug/socket combinations to test and ensure that the correct fit is made. Also, the consumer can choose a plug in accessory without having to seek the assistance of a sales clerk to determine which plug style is correct. Retailers are thereby assisted in knowing that the consumers can select the correct accessory plug style with little or no assistance from the retailer. Still further, the retailer can display items for sale knowing the items will likely remain in the package until the time of sale, reducing the likelihood that consumers will open the packages and take the items out to test the fit before purchase, reducing the likelihood of damage to the package or item, and removing the need to reunite opened items with their packages and repackage them.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A package for sale of an item comprising:
a passage portion of he package for allowing a portion of the item to extend from an interior of the package to an exterior; and
a securing device for securing the portion of the item relative to the package.

2. The package according to claim 1, wherein said securing device comprises:
a locking collar portion; and
a lock end cover portion.

3. The package according to claim 2, wherein said locking collar comprises:
a flange member adapted to interact with an interior face of the package to prevent movement of the locking collar beyond a position;
an extending portion extending to the exterior of the package.

4. The package according to claim 3, wherein said locking collar portion includes an opening therein to allow a portion of the item to extend through the locking collar to the exterior.

5. The package according to claim 3, wherein said lock end cover portion includes a mating portion adapted to interact with the extending portion to secure the locking collar portion relative to the package.

6. The package according to claim 5, wherein said lock end cover portion comprises a cotter pin.

7. The package according to claim 5, wherein said lock end cover portion comprises a split disk member.

8. A method of providing an item having a plug or connector portion at point of sale, comprising the steps of:
providing the item in a package having a wall portion defining an interior to the package;
positioning the plug or connector portion of the item to be external of the package interior, with substantially the rest of the item remaining in the interior portion.

9. The method according to claim 9, further comprising:
providing a lock collar portion at an interior of the package, with a portion of the lock collar extending through the wall portion;
passing the plug through the lock collar portion to extend at least partially out of the package interior; and
securing the lock collar relative to the package to prevent substantial movement thereof, while enabling access to the plug from the exterior of the package.

10. A device for holding a cord connector outside of a package for access thereto without opening the package, comprising:
a lock collar member having a flange member for engagement against an interior face of the package, said lock collar member having an extending neck portion adapted to pass through an aperture in the package, said lock collar member further having a passage therein adapted to receive and engage the connector; and
a securement member for interacting with the neck member at an exterior of the package, to assist in maintaining the lock collar and package and connector in relative positions to one another, with the connector presented to the exterior of the package.

11. The device according to claim 10, wherein the lock collar member has a split configuration.

12. The device according to claim 10, wherein the securement member has a split configuration.

13. The device according to claim 10, wherein said securement member comprises a cotter pin.

14. The device according to claim 10, wherein said securement member comprises a disk shaped member.

15. The device according to claim 10, wherein said disk shaped member includes a split configuration to a portion thereof.

16. The device according to claim 10, wherein said package includes an electrical device accessory therein and the cord connector is a portion of the accessory.

17. The device according to claim 16, wherein said electrical device accessory is a cellular telephone accessory.

18. The device according to claim 16, wherein said electrical device accessory is a cellular telephone power cord accessory.

19. The device according to claim 16, wherein said electrical device accessory is a computer game accessory.

20. The device according to claim 16, wherein said electrical device accessory is a PDA.
